(19) United States
(12) Patent Application Publication
(10) Pub. No.: US 2007/0058827 A1
(43) Pub. Date: Mar. 15, 2007

(54) Loudspeaker

(76) Inventor: Richard Topliss, Cambridge (GB)

Correspondence Address: NIXON & VANDERHYE, PC, 901 NORTH GLEBE ROAD, 11TH FLOOR, ARLINGTON, VA, 22203, US

(21) Appl. No.: 10/575,879

(22) PCT Filed: Oct. 11, 2004
(86) PCT No.: PCT/GB04/04314

§ 371 Date: Apr. 14, 2006

(30) Foreign Application Priority Data
Oct. 14, 2003 (GB) 0324051.2

(51) Int. Cl. H04R 25/00

(52) U.S. Cl. 381/190

(57) ABSTRACT

A loudspeaker comprises a support which may be a portion of the housing of an electronic device and a diaphragm mounted on the support. A piezoelectric actuator arranged to bend on activation providing relative movement between two ends of the actuator is coupled at each of its ends to the diaphragm to vibrate the diaphragm on activation and generate sound. One end of the actuator coupled to a portion of the diaphragm at the edge of the diaphragm is fixed relative to the support.

This invention relates to a loudspeaker which is particularly suitable for use in an electronic device of relatively small size as to be portable, such as a mobile phone, Personal Digital Assistant (PDA) or lap-top computer.

An example of a type of loudspeaker suitable for use in a portable electonic device is described in the commonly owned international patent application WO-03/001841. This type of loudspeaker is referred to herein as a “C-Window speaker” and comprises a diaphragm driven by a “C-morph actuator”, which is a piezoelectric actuator configured to operate like a bimorph and shaped as a cylinder with a sector removed (hence it is C-shaped in cross-section). One end of the actuator is attached to the diaphragm while the other end of the actuator is attached to the housing of the electronic device. The C-Window speaker allows a panel in the housing of various products, such as mobile phones and PDAs, to be driven as a loudspeaker, and provides the following advantages:
The speaker is very low profile, so does not take up much room inside the product.
The C-morph actuator looks electrically like a capacitor, and consumes little power.
For products that use a display, such as mobile phones, the diaphragms may be the polycarbonate screens currently used to protect the LCD.
Use of such loudspeakers allows the product to be more effectively sealed against water and dust.
The sound produced is diffuse, preventing hearing damage if used at loud volume close to the ear.
The sound quality is superior to equivalent sized speakers.
The parts and construction of the speaker are simple, potentially yielding cost advantages over traditional speakers.

However, the C-window speaker and other loudspeakers employing a piezoelectric actuator introduce a number of problems in manufacture, as follows. In particular, conventional loudspeakers driven by a voice-coil are self-contained and can be mounted in the housing of the electronic device (such as mobile phone) by a simple glueing or mechanical fixing operation. Also, such voice-coil loudspeakers can be tested before being assembled into the product. In contrast, loudspeakers employing a piezoelectric actuator such as the C-window speaker require a more complex procedure for assembly into the product, as both the diaphragm edges and the fixed end of the actuator need to be fixed to the housing. Also, the loudspeaker cannot be pre-tested as it does not operate as a speaker until fixed to the casework.

A subsidiary issue with the C-window speaker and other loudspeakers employing a piezoelectric actuator is that the actuator is vulnerable to over-stressing in use, as for example if the diaphragm is accidentally poked or pushed by an external object. Since the two ends are fixed to the diaphragm and the casework respectively, such a situation in which the diaphragm is caused to move relative to the casework may over-stress the actuator and cause mechanical failure.

According to a first aspect of the present invention, there is provided a loudspeaker comprising:

a support;

a diaphragm mounted on the support; and

a piezoelectric actuator arranged to provide, on activation, relative movement between two ends of the actuator, wherein each of said ends of the actuator is coupled to the diaphragm to vibrate the diaphragm on activation of the actuator.

This arrangement for the loudspeaker provides advantages in assembly whilst still allowing the actuator to vibrate the diaphragm to generate sound. In particular, as a result of each end of the actuator being coupled to the diaphragm it is possible to manufacture an assembly consisting of the diaphragm and actuator separately from the final stage of mounting the assembly to the support. Thus the manufacture of the loudspeaker assembly may be done by a first component manufacturer who has particular expertise in the handling and processing of piezoelectric materials. The loudspeaker assembly may then be supplied to a different manufacturer who mounts the assembly to the support. As it is not necessary to bond the piezoelectric actuator directly to the support, this is easily achieved without particular expertise in the bonding of piezoelectric materials. These advantages are felt particularly where the support is a portion of a housing of an electronic device. In such case, the manufacturer of the electronic device is typically assembling large numbers of different types of components and desires simple manufacture, for example by dropping functional sub-assemblies into the housing. The present invention meets this requirement in respect of a loudspeaker integrated into the housing, because the assembly may be mounted without the need to fix the piezoelectric actuator to the housing.

As the loudspeaker assembly may be provided separately from the support, according to a second aspect of the present invention, there is provided [claim 19] a loudspeaker assembly comprising:

a diaphragm; and

a piezoelectric actuator arranged to provide, on activation, relative movement between two ends of the actuator, each of said ends being coupled to the diaphragm to vibrate the diaphragm on activation of the actuator.

Preferably, the diaphragm is mounted to the support with a portion of the diaphragm coupled to one end of the actuator being fixed relative to the support.

In this case, the one end of the actuator is effectively fixed by means of the portion of the diaphragm to which is coupled being fixed relative to the support. Therefore, the other end of the actuator is free to move on activation of the actuator, thereby driving vibration of the diaphragm. As one end of the actuator is effectively fixed and the other end is effectively free, in this arrangement the piezoelectric actuator provides movement of the diaphragm as though the actuator itself was coupled directly to the support.

Fixing of the portion of the diaphragm relative to the support may be achieved directly, for example by the portion of the diaphragm being coupled directly to the support, or may be achieved indirectly, for example by means of the loudspeaker further comprising a rigid bridge element coupled to the one end of the actuator and also coupled to a further portion of the diaphragm separate from the actuator, that further portion of the diaphragm being coupled to the support.

Typically, the one end of the actuator which is effectively fixed is coupled to an edge of the diaphragm. Thus, the other end of the actuator is coupled to the diaphragm inside the edge for driving vibration of the diaphragm.

Advantageously, the diaphragm has an aperture separating the portions of the diaphragm which are coupled to the ends of the actuator. The aperture has the advantage of reducing the resistance of the diaphragm to movement as compared to there being no aperture. This improves the performance of the loudspeaker.

The loudspeaker may further comprise a seal member between the diaphragm and the support extending around the periphery of a portion of the diaphragm. In this case, the one end of the actuator is coupled to a portion of the diaphragm outside the seal member and the opposite end of the actuator is coupled to a portion of the diaphragm adjacent or inside the seal member.

Advantageously, the actuator is longer in transverse extent than extent between the two ends. Such a relatively long transverse length has two advantages. Firstly, it increases the stiffness of the connection between the piezoelectric actuator and the diaphragm which improves the connection strength. Secondly, it increases the force which may be applied by a piezoelectric actuator having a given extent between the two ends.

Advantageously, the loudspeaker further comprises at least one stop member coupled to the diaphragm adjacent said one end of the actuator and extending to a position adjacent the opposite end of the actuator to limit the movement of the moveable portion of the diaphragm coupled to the opposite end of the actuator. The stop member has the benefit of preventing a degree of movement which might damage the actuator. As the stop member is coupled to the diaphragm itself, this produces corresponding advantages as are achieved by the piezoelectric actuator being coupled to the diaphragm, as discussed above.

The present invention may be applied with particular advantage to an actuator which extends between the two ends in a curve, for example a sector of a circle as in the type of loudspeaker described above referred to as a C-Window speaker. On the other hand, the present invention may equally be applied to a piezoelectric actuator of a different form, for example one which is straight.

To allow a better understanding, embodiments of the present invention will now be described by way of non-limitive example, with reference to the accompanying drawings, in which:

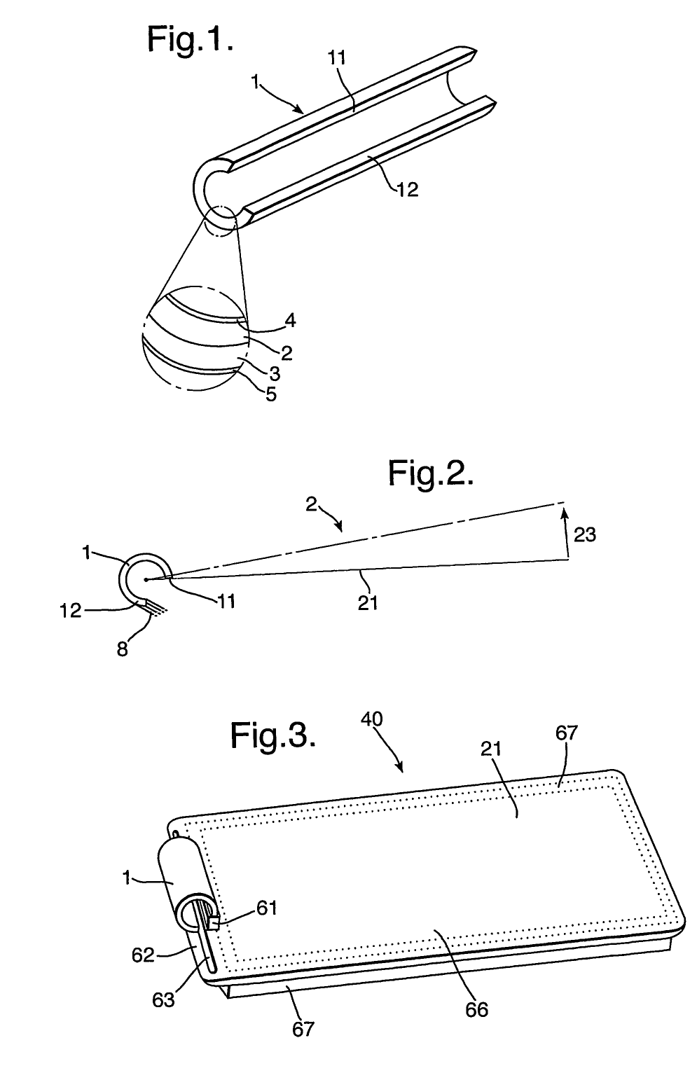

FIG. 1 is a perspective view of a C-morph actuator including a detailed view of the layered construction;

FIG. 2 is a schematic side view of a loudspeaker assembly using the actuator of FIG. 1;

FIG. 3 is a perspective view of a loudspeaker assembly,

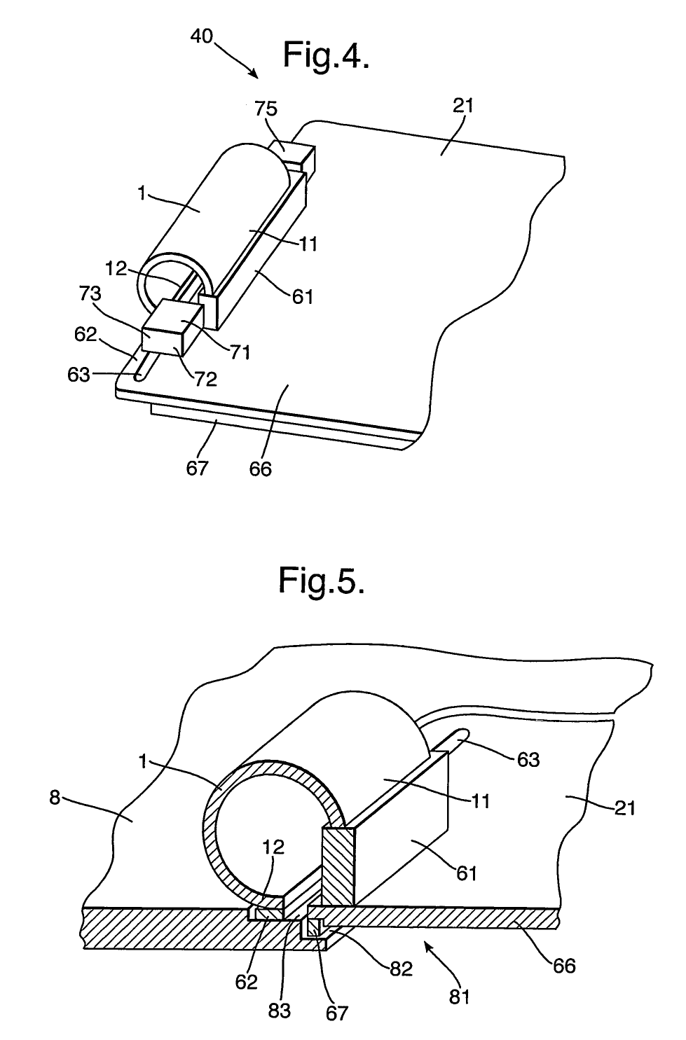

FIG. 4 is a detailed perspective view of part of the loudspeaker assembly of FIG. 3;

FIG. 5 is a cross-sectional view of the loudspeaker assembly mounted in a support to form a loudspeaker,

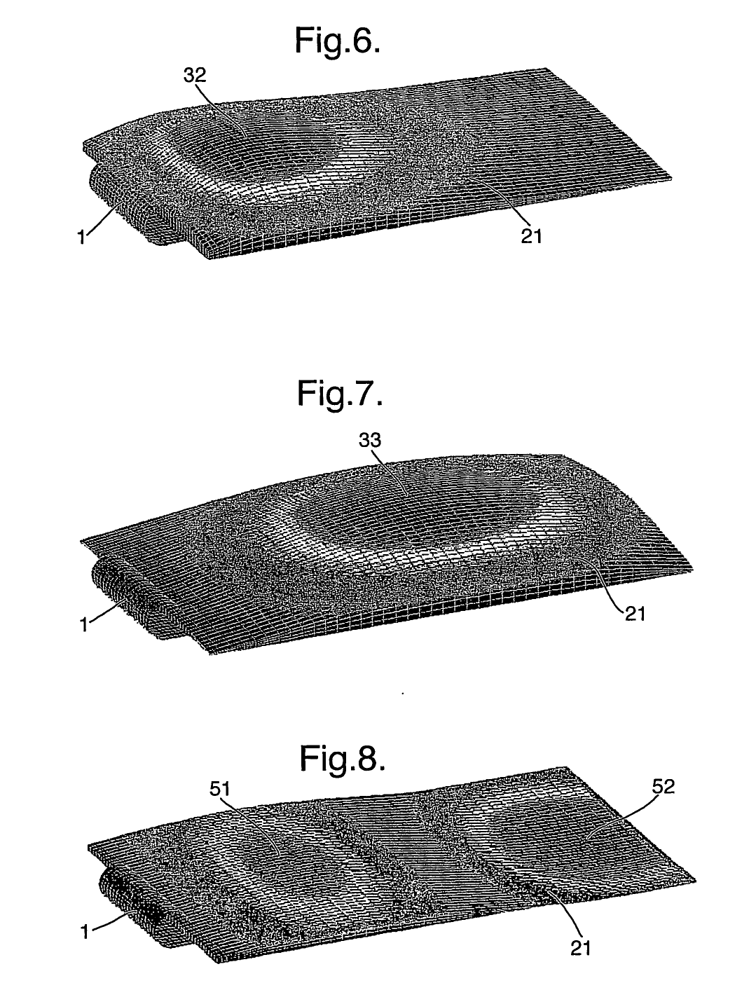

FIG. 6 shows the static deformation of the diaphragm in the loudspeaker;

FIG. 7 shows the displacement of the diaphragm in the loudspeaker at the fundamental resonant frequency,

FIG. 8 shows the displacement of the diaphragm in the loudspeaker at the first harmonic resonant frequency, and

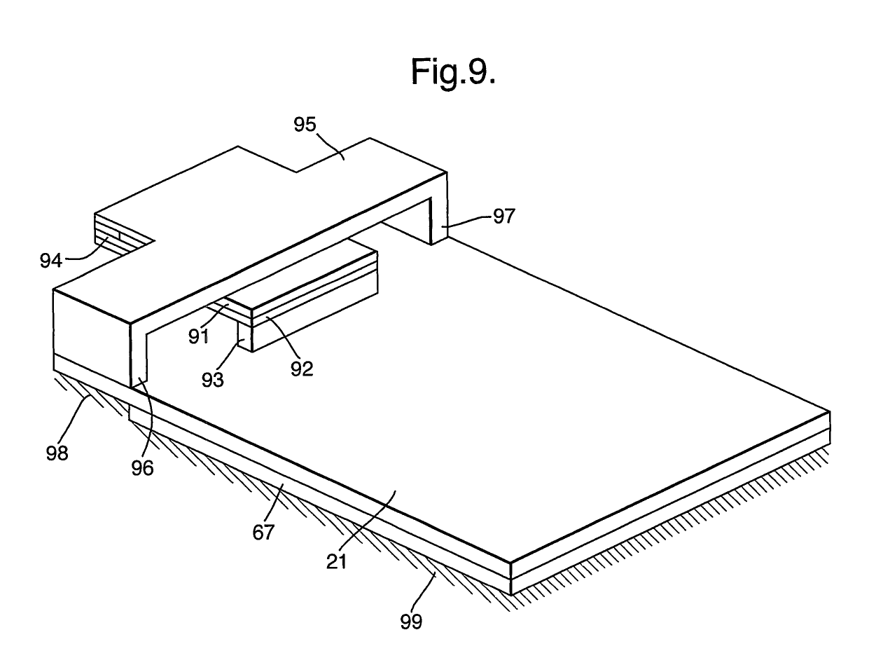

FIG. 9 is a perspective view of a further loudspeaker.

There will first be described an embodiment of the invention of a type using a C-morph actuator to provide a C-Window speaker.

FIG. 1 shows the C-Morph actuator 1. The actuator 1 has a bimorph bender construction comprising two layers 2 and 3 of piezoelectric material arranged between two electrodes 4 and 5. The piezoelectric material of the layers 2 and 3 is preferably a piezelecrtic ceramic such as PZT. The layers 2 and 3 of piezoelectric material are oppositely poled so that activation by application of a voltage across the electrodes 4 and 5 causes bending of the actuator 1. The actuator 1 extends in a curve between two ends 11 and 12, in particular a sector of a circle, in this case about ¾ of a complete circle. Thus bending of the actuator 1 on activation causes relative movement of the two ends 11 and 12, including a rotational component.

FIG. 2 is a schematic diagram illustrating the operation of the actuator 1 in a loudspeaker 2 of the type described above referred to as a C-Window in which the actuator 1 is coupled to a diaphragm 21 to generate sound. One end 11 of the actuator 1 is coupled to a support 8 and is therefore fixed. The opposite end 12 of the actuator 1 is rigidly coupled to the diaphragm 21. When activated, the opposite end 12 of the actuator 1 rotates relative to the one end 11 which is fixed, thereby rotating the diaphragm 21 as shown schematically by the arrow 23 (in fact there being some variation in displacement of the diaphragm 21 over its area as described in more detail below). In this manner, the actuator 1 is used to vibrate the diaphragm 21 to generate sound.

The actuator 1 is elongate in the sense that its transverse extent is greater than its extent between the two ends 11 and 12. This increases the rigidity of the coupling between the actuator 1 and the diaphragm 21 and also increases the force applied for an actuator 1 having a given extent between its two ends 11 and 12.

FIGS. 3 and 4 show a loudspeaker assembly 40 comprising the actuator 1 coupled to the diaphragm 21. In this loudspeaker assembly 40, the diaphragm 21 is transparent and forms the protection layer for the LCD screen of an electronic device such as a mobile phone The loudspeaker assembly 40 with the uppermost side of the diaphragm 21 in FIGS. 3 and 4 facing an LCD screen (not shown) and the lowermost side of the diaphragm 21 in FIGS. 3 and 4 facing outwardly.

The actuator 1 is coupled at its two ends 11 and 12 to different portions of the diaphragm 21, by a suitable adhesive. One end 12 of the actuator 1 is coupled directly to a portion 62 of the diaphragm 21 at the edge of the diaphragm 21. In use, this one end 12 is effectively fixed. The end 12 is coupled to the diaphragm 21 by a side surface of the actuator 1. As a result, the actuator 1 extends from the fixed end 12 initially outwardly of the central portion 66 of the diaphragm 21 and then in a loop over the fixed end 12. This orientation, as compared to the end surface of the end 12 of the actuator 1 facing the diaphragm 21, allows use of a long actuator 1 and reduces the stress on the coupling between the fixed end 12 and the diaphragm caused by the displacement of the actuator 1 on activation.

The opposite end 11 of the actuator 1 is coupled indirectly to the central portion 66 of the diaphragm 21 via a spacer 61. In use, this opposite end 11 is effectively free and is movable to drive vibration of the diaphragm 21 to generate sound. The end surface of the free end 11 of the actuator 1 faces the diaphragm 21 and thus all the rotational movement of the end 11 of the actuator is in a direction perpendicular to the diaphragm 21.

The diaphragm 21 has an aperture 63 shaped as a slit arranged between and separating the portions 62 and 66 to which the actuator 1 is coupled. Therefore the portion 62 of the diaphragm 21 is essentially connected to the central portion 66 of the diaphragm 21 at the corners 64, 65 of the diaphragm 21. This reduces the resistance of the diaphragm 21 to motion driven by the actuator 1. In the absence of the aperture 63, the material of the diaphragm 21 between the portions 62 and 66 would restrict the motion of the diaphragm 21.

The diaphragm 21 has a seal member 67 extending around the periphery of the central portion 66. The seal member 67 is on the lowermost surface of the diaphragm 21 in FIGS. 3 and 4 and is shown in dotted outline in FIG. 3. Thus the fixed end 12 of the actuator 1 is coupled to the diaphragm 21 outside the seal member 67 and the free end 11 of the actuator is coupled adjacent or inside the seal member 67.

As shown in FIG. 5, the diaphragm assembly 40 is mounted to a support 8 to form a loudspeaker. The support 8 is a portion of the housing of an electronic device such as a mobile telephone. The support 8 has an aperture 81 to which the diaphragm 21 is aligned. The aperture 8 is sized so that the central portion 66 of the diaphragm 21 overlaps the peripheral edge of the aperture 81. Around that peripheral edge of the aperture 81 the support is formed with a seat 82 recessed into the support 8. The seal member 67 is seated on the shelf and coupled thereto by a suitable adhesive. In this manner the seal member 67 seals between the diaphragm 21 and the support 8. The seal member 67 is compliant and so the central portion 66 of the diaphragm 21 is free to move when driven by the actuator 1.

The portion 62 of the diaphragm 21 to which is coupled the fixed end 12 of the actuator 1 is coupled directly to a ledge 83 formed in the support 8 by a suitable adhesive. By this means the fixed end 12 of the actuator 1 is effectively fixed to the support 8. This provides a good reaction against which the actuator 1 can rotate and vibrate the diaphragm 21. Since the region bonded to the support 8 and the diaphragm 21 are joined at the corners 64 and 65 of the diaphragm 21, this has the effect of stiffening the diaphragm 21 and reducing its movement. However, this effect is quite small, and can be offset by choice of the size of the actuator 1.

The loudspeaker assembly 40 can be manufactured as a single functional unit before the final stage of mounting the loudspeaker assembly to the support 8. This is advantageous in manufacture as the loudspeaker assembly 40 can be manufactured independently, for example by a manufacture with particular expertise in the field of piezoelectric materials, and can undergo some form of performance testing immediately.

Subsequent mounting of the loudspeaker assembly 40 to the support 8 is a simple manufacturing operation as it is straightforward to position the loudspeaker assembly 40 on the inside of the support and to couple the portion 62 of the diaphragm 21 and the seal member 67 to the support 8. One practical mounting method is to dispense a bead of compliant silicone around the seat 82 and along the ledge 83. By making the bond line much thinner in this region, this region will be much more stiffly bonded to the support 8. Therefore the entire mounting process into the support 8 may involve the dispensing of one material onto the support 8, and pressing the loudspeaker assembly 40 in place. This makes the assembly operation very similar to operations currently used in the assembly of such products In particular, there is no need to mount the diaphragm 21 to the support 8, and then couple the actuator 1 to both the diaphragm 21 and the support 8.

The nature of the seal member 67 will now be described. The primary purpose of the seal member 67 is to act as a seal, for which a completely flexible piece of material, which does not restrain the motion of the diaphragm, is adequate. However, it is advantageous to use a material which provides some damping as this improves the flatness of the frequency response of the loudspeaker. The material of the seal member 67 may be foamed elastomer with high compliance (low stiffness), for example a polyurethane foam. For example, the Compression Force Deflection of the material of the seal member 67 is preferably in the range 25-500 kPa, more preferably 100-300 kPa (measured at 0.2 inches/minute strain rate and 25% deflection). The Durometer hardness on the Shore “A” scale is preferably in the range 8-45, more preferably about 25.

An example of a suitable material for the seal member 67 is a polyurethane foam, for example a foam supplied under the name PORON (trade mark) by Rogers Corporation such as PORON 4701-40 Soft, preferably high density grade which has a density of 480 kg/m3, thickness 0.8 mm and typical Compression Force Deflection of 173 kPa and Shore “A” hardness of 25.

As shown in FIG. 4, the loudspeaker assembly 40 also has two identical stop members 71 and 75. One end 73 of the stop member 71 is coupled to the portion 62 of the diaphragm 2 adjacent the fixed end 12 of the actuator. The other end 72 of the stop member 71 extends to a position adjacent the free end 11 of the actuator overlapping the diaphragm 21. The stop member 71 is shaped such that there is a gap between the stop member 71 and the diaphragm 21. The gap is designed to allow relative movement of the parts during normal operation, but to limit the travel when the diaphragm 21 suffers an accidental external deflection (from outside, or upwards in FIG. 47), thereby reducing the likelihood of damage to the actuator 1. As the stop members 71 and 75 are coupled to the diaphragm 21, they may be manufactured as part of the loudspeaker assembly 40 before mounting to the support 8. This minimises the complexity of assembling the loudspeaker, and removes the tolerance issues in assembling the stop members 71 and 75.

The vibration of the diaphragm 21 in the generation of sound will now be described. Although FIG. 2 is useful for understanding, in fact the motion of the diaphragm 21 is more complicated.

For initial understanding, it is noted that the seal member 67 has the effect that statically the diaphragm 21 is prevented from moving in the manner shown in FIG. 2. FIG. 6 shows the results of a Finite Element Analysis (FEA), where the actuator 1 has deformed statically in response to an applied voltage. FIG. 6 shows the actuator 1, the diaphragm 21, and the position of maximum static displacement 32. The displacement of the diaphragm 21 has been exaggerated relative to its area for clarity.

Furthermore, in practice, the static displacement of the diaphragm 21 bears little relation to the displacement of the diaphragm 21 at the audible frequencies of interest. The material used for the diaphragm 21, its stiffness and density determine the resonant frequencies of the diaphragm 21. For most applications, the material properties of the diaphragm 21 are such that it is operating above its first resonant frequency at the frequencies of interest. The resonant frequencies (and the fundamental frequency in particular) are also affected by the volume of air behind the diaphragm 21 inside the support 8, since this adds stiffness to the system.

FIG. 7 is a FEA, showing how a typical diaphragm 21 displaces at its fundamental resonant frequency in the particular case of a diaphragm of size 44 mm by 71 mm made from 1 mm thick polycarbonate, the same material currently used to protect LCD screens in mobile phones. Without any added air stiffness, this resonance occurs at approximately 380 Hz. The maximum positive displacement 33 is at a different position from the static case shown in FIG. 6.

In contrast FIG. 8 shows the FEA results of the first harmonic of the diaphragm 21, for the same conditions as FIG. 7. This occurs at approximately 650 Hz. The analysis shows both a maximum positive displacement 51 and a maximum negative displacement 52. This shows that, at this frequency the diaphragm 21 is no longer moving as a rigid body; the diaphragm 21 is said to have “broken up”. Therefore, in the audible region of interest, it is likely that the diaphragm 21 will have “broken up” and not move as a rigid body.

This has several implications:
Above the first harmonic resonant frequency, the volume of air acting as a spring behind the diaphragm becomes far less important, because the diaphragm is not moving in phase. The air is not being asked to change volume, but merely shift from one place to another inside the product.
At resonances, the amplitude of vibration of the diaphragm increases, maximising the sound output.
It does not matter that the actuator is only acting on one end of the diaphragm, since the energy travels across the diaphragm from the actuator.
The frequency response is not as flat as a speaker operating as a piston. However, for its size, it operates at a lower frequency, and has a comparable flatness of frequency response to conventional voice coil speakers of similar size.

The material of the diaphragm 21 is chosen bearing these points in mind. There is considerable flexibility in the choice of material, one preferred option being polycarbonate 1 mm thick.

FIG. 9 shows a loudspeaker with an alternative form of actuator 91 which is straight rather than curved. In general this loudspeaker has the same arrangment and operation as the loudspeaker shown in FIG. 1 except as follows.

The actuator 91 is coupled at one end 92 to a bridge element 95 and at the other end 94 via a spacer 93 to the diaphragm 21. This bridge element 95 is also coupled to further portions 96 and 97 of the diaphragm 21 separated from actuator 91, in particular arranged at the edge of the diaphragm 21 outside a seal member 67. The diaphragm 21 is mounted to a support 8 by the further portions 96 and 97 of the diaphragm 21 being coupled to the support 8 at the position shown by the shading 98 and by the seal member 67 being coupled to the support 8 as shown by the shading 99. The bridge element 95 is rigid in the sense that it is not moved by the actuator 91. Thus the bridge element 95 has the effect of indirectly coupling to the support 8, and fixing, the one end 94 of the actuator 91 and the portion of the diaphragm coupled thereto.

1. A loudspeaker comprising:
a support;
a diaphragm mounted on the support; and
a piezoelectric actuator arranged to provide, on activation, relative movement between two ends of the actuator, wherein each of said ends of the actuator is coupled to the diaphragm to vibrate the diaphragm on activation of the actuator, a portion of the diaphragm coupled to one end of the actuator being fixed relative to the support.

2. (canceled)

3. A loudspeaker according to claim 1, wherein the one end of the actuator is coupled to a portion of the diaphragm at the edge of the diaphragm.

4. A loudspeaker according to claim 1, wherein the diaphragm has an aperture separating portions of the diaphragm coupled to the respective ends of the actuator.

5. A loudspeaker according to claim 1, further comprising a seal member between the diaphragm and the support extending around the periphery of a portion of the diaphragm, wherein the one end of the actuator is coupled to a portion of the diaphragm outside the seal member and the opposite end of the actuator is coupled to a portion of the diaphragm adjacent or inside the seal member.

6. A loudspeaker according to claim 1, wherein the actuator is longer in transverse extent than in extent between the two ends.

7. A loudspeaker according to claim 1, further comprising at least one stop member coupled to the diaphragm adjacent said one end of the actuator and extending to a position adjacent said opposite end of the actuator for limiting the movement of the portion of the diaphragm coupled to the opposite end of the actuator.

8. A loudspeaker according to claim 1, wherein the portion of the diaphragm coupled to one end of the actuator is fixed relative to the support by being coupled directly to the support.

9. A loudspeaker according to claim 1, further comprising a rigid bridge element coupled to the one end of the actuator and also coupled to a further portion of the diaphragm separated from the actuator, the portion of the diaphragm coupled to one end of the actuator being fixed relative to the support by the further portion of the diaphragm being coupled to the support.

10. A loudspeaker according to claim 1, wherein the actuator extends between the two ends in a curve.

11. A loudspeaker according to claim 10, wherein said curve is a sector of a circle.

12. A loudspeaker according to claim 10, wherein the opposite end of the actuator has an end surface facing the diaphragm.

13. A loudspeaker according to claim 12, wherein said opposite end of the actuator is coupled indirectly to the diaphragm by a spacer.

14. A loudspeaker according to claim 10, wherein one end of the actuator is coupled directly to the diaphragm by a side surface of the actuator, the actuator extending from said one end in a loop over said one end.

15. A loudspeaker according to claim 1, wherein the actuator is straight.

16. A loudspeaker according to claim 1, wherein the actuator has a bender construction.

17. A loudspeaker according to claim 1, wherein the actuator comprises ceramic piezoelectric material.

18. A loudspeaker according to claim 1, wherein the support is a portion of a housing of an electronic device.

19. A loudspeaker assembly comprising:
a diaphragm; and
a piezoelectric actuator arranged to provide, on activation, relative movement between two ends of the actuator, each of said ends being coupled to the diaphragm to vibrate the diaphragm on activation of the actuator, one end of the actuator is coupled to a portion of the diaphragm at the edge of the diaphragm.

20. (canceled)

21. A loudspeaker assembly according to claim 19, wherein the diaphragm has an aperture separating portions of the diaphragm coupled to the respective ends of the actuator.

22. A loudspeaker assembly according to claim 19, further comprising a seal member between the diaphragm and the support extending around the periphery of a portion of the diaphragm, wherein the one end of the actuator is coupled to a portion of the diaphragm outside the seal member and the opposite end of the actuator is coupled to a portion of the diaphragm adjacent or inside the seal member.

23. A loudspeaker assembly according to claim 19, wherein the actuator is longer in transverse extent than in extent between the two ends.

24. A loudspeaker assembly according to claim 19, further comprising at least one stop member coupled to the diaphragm adjacent said one end of the actuator and extending to a position adjacent said opposite end of the actuator for limiting the movement of the portion of the diaphragm coupled to the opposite end of the actuator.

25. A loudspeaker assembly according to claim 19, further comprising a rigid bridge element coupled to the one end of the actuator and also coupled to a further portion of the diaphragm separated from the actuator.

26. A loudspeaker assembly according to claim 19, wherein the actuator extends between the two ends in a curve.

27. A loudspeaker assembly according to claim 26, wherein said curve is a sector of a circle.

28. A loudspeaker assembly according to claim 26, wherein the opposite end of the actuator has an end surface facing the diaphragm.

29. A loudspeaker assembly according to claim 28, wherein said opposite end of the actuator is coupled indirectly to the diaphragm by a spacer.

30. A loudspeaker assembly according to claim 19, wherein one end of the actuator is coupled directly to the diaphragm by a side surface of the actuator, the actuator extending from said one end in a loop over said one end.

31. A loudspeaker assembly according to claim 19, wherein the actuator is straight.

32. A loudspeaker assembly according to claim 19, wherein the actuator has a bender construction.

33. A loudspeaker assembly according to claim 19, wherein the actuator comprises ceramic piezoelectric material.
